(19) United States
(12) Patent Application Publication
(10) Pub. No.: US 2025/0115345 A1
(43) Pub. Date: Apr. 10, 2025

(54) RUDDER TO DECREASE DRAG AND INCREASE TURNING EFFICIENCY OF A FLUID TRAVERSING AIR AND WATER CRAFT

(71) Applicant: William Woodruff, Alexandria, VA (US)

(72) Inventor: William Woodruff, Alexandria, VA (US)

(21) Appl. No.: 18/483,591

(22) Filed: Oct. 10, 2023

(51) Int. Cl. B63H 25/38; B64C 9/06

(52) U.S. Cl. CPC B63H 25/06; B64C 9/00

(57) ABSTRACT

A rudder apparatus designed to significantly reduce drag near a centerline of a watercraft or aerial vehicle in which it is attached and to significantly increase a turning efficiency of the watercraft or aerial vehicle in which it is attached.

### STATEMENT REGARDING FEDERALLY SPONSORED RESEARCH OR DEVELOPMENT

Not applicable.

### COPYRIGHT NOTICE

A portion of this disclosure contains material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever. 37 C.F.R 1.71(d).

### BACKGROUND OF THE INVENTIVE CONCEPT

### 1. Field of the Invention

The present inventive concept relates to an improved (rudder, aileron, etc.) apparatus designed to significantly improve control authority of such control surfaces, while decreasing drag, turbulence, and cavitation generated when employing those control surfaces to maneuver a watercraft, an aircraft or any other body travelling through a fluid medium such as air or water. The principle as depicted herein shows the application of this device primarily in the context of a rudder for a small watercraft, such as a kayak. The scope of employment of this device is not limited to such basic watercraft; rather, the principle disclosed herein is scalable, and is equally applicable to large and small watercraft, in both surface and subsurface vehicles. Furthermore, the disclosed device is also applicable to vehicles moving through the air, or any other fluid medium. In addition, while the device is primarily described herein as a rudder (i.e., a device to control a vehicle on the yaw axis), the device is equally applicable to devices that control a vehicle on the pitch axis (e.g. elevators or dive planes), and the roll axis (e.g. ailerons, or offset dive planes). More particularly, but not exclusively, this inventive concept relates to a control apparatus designed to significantly decrease the induced and parasitic drag of the control surface nearest the center of drag of the vehicle (typically on the centerline of a watercraft), and offset the induced and parasitic drag of the control surface by displacing the control surface in the direction of the desired movement of the vehicle. This results in increased control authority, allowing the use of smaller control surfaces, thus reducing overall drag. The use of smaller control surfaces, and the ability to attain similar control authority with less deflection of the vehicle's control surfaces also reduces turbulence and/or cavitation associated with the control surfaces.

### DESCRIPTION OF THE RELATED ART

Rudders have been used since the beginning of time to aid in steering craft, such as kayaks, canoes, sailboats, and larger vessels. With the development of aerial vehicles since the mid-1800's, similar control mechanisms (rudders, flaps, ailerons, etc.) have also been employed to similarly control vehicles in flight. These control surfaces are most frequently mounted either on the stern of a vehicle, on top of the vehicle, or underneath the vehicle. In the case of Canard designs, such control surfaces may be mounted on the forward part of the vehicle, or even extended forward of the bow/nose of the vehicle. Such control surfaces are commonly configured to include a rotatable shaft, which extends downward underneath a boat's hull, or at the stern end thereof, and a rudder blade extending horizontally from the shaft. (These control surfaces may also be attached to the vehicle without a rotatable shaft, using hinges, flexible membranes, or similar attachments.) This design enables the rudder to steer the boat as the shaft is rotated to redirect an angle of the rudder blade with respect to the direction in which the boat is traversing in the water.

FIG. 1 illustrates a conventional rudder 100 used to steer craft, such as kayaks, canoes, sailboats, larger vessels and even aerial vehicles. In this application, rudder 100 includes a solid rotatable shaft 102, which extends downward vertically from the underside of the keel, or from the stern end of a hull of a craft, such as a boat B, and a rudder blade 104 which is generally attached to a bottom end of the shaft 102 and extends outward at a 90 degree angle from the shaft 102. The shaft 102 is generally disposed at the stern of the boat B (or other craft) and along a centerline of the boat B (between the left (port) side and the right (starboard) side thereof). As the boat B traverses water W the shaft 102 can be rotated in both clockwise and counterclockwise directions in order to cause the surfaces of the rudder blade 104 to become deflected in the water, thus creating a greater surface area of the rudder blade 104 to cause a deflection of the water W as the rudder blade 104 traverses through the water W. This deflection of the water (or air, in the case of an aircraft), creates two forces that effect the speed and the direction of travel of the vehicle. The water (or air) on the side of the deflection travels a longer path than the water nearer the centerline of the craft, which causes a lower pressure area which, in turn, creates a lifting force that causes the vehicle to turn (in the case of a rudder). Friction created between the rudder blade 104 and the water W will result in a greater drag on the rudder blade 104 with respect to the water W. At the same time, increasing the lateral exposure of the rudder/control surface also creates drag, which slows the vehicle down. If this drag force is equally distributed on opposite sides of the centerline of the vehicle, this drag will slow the vehicle with little or no turning effect. If this drag force is displaced to either side of the vehicle, this drag will cause the boat B to turn in the direction in which the drag is created. In other words, looking downward at the boat B and shaft 102, as the shaft 102 is rotated clockwise, as illustrated by a clockwise arrow in FIG. 1, the boat B will be forced to begin turning left. Alternatively, if the shaft 102 is rotated counterclockwise (illustrated by the counterclockwise arrow in FIG. 1) the boat B will be forced to begin turning right. In fact, deflecting a control surface, such as a rudder on a boat, always produces a drag. However, when the drag is on the center of drag (typically the centerline) of the boat this drag slows the boat down, while contributing little or nothing to actually steering the boat B. With the rudder 100 a large portion of the drag caused by the rudder blade 104 is near the centerline of the boat B. Accordingly, the rudder 100 causes the boat B to have a high amount of drag, thus slowing the boat B down through the water W, without contributing to a steering force.

Accordingly, there is a need for a rudder for a watercraft or other vehicles traveling through fluid mediums, that will create a minimum amount of drag while maximizing the turning force exerted on the vehicle.

There is also a need for a rudder for a watercraft or other vehicles traveling through fluid mediums, that eliminates control surface area near the centerline of drag of the watercraft, and moves the centers of lift and drag away from the centerline, placing the centers of lift and drag away from their attachment points in the direction of the desired vehicle movement.

### SUMMARY OF THE INVENTIVE CONCEPT

The present general inventive concept provides a rudder designed to decrease drag and increase turning efficiency for a craft which traverses through a fluid, such as water. More particularly, but not exclusively, this inventive concept relates to a rudder designed to decrease drag and increase turning efficiency for craft, such as kayaks, canoes, sailboats, etc., which traverse through a fluid, such as water, and for air crafts.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a rudder used to turn a watercraft, aerial vehicle, or other vehicle moving through a fluid medium comprising: an elongated rotatable shaft; a rudder blade extending in parallel with the elongated shaft; and at least one arm connecting the elongated shaft to the rudder blade such that the rudder blade is disposed at a distance away from the elongated shaft.

In an exemplary embodiment, at least one arm can include: a first horizontal arm connecting a bottom portion of the shaft to a top portion of the rudder blade; and a second angled arm connecting a bottom portion of the shaft to a bottom portion of the rudder blade such that an open triangular space is formed between the first horizontal arm, the second angled arm and the rudder blade

In another exemplary embodiment, the bottom portion of the rudder blade is parallel with the top portion of the rudder blade.

In another exemplary embodiment, the bottom portion of the rudder blade is formed to have a same angle as the second angled arm and is integral therewith.

In still another exemplary embodiment, the at least one arm can include: a first horizontal arm connecting a portion of the shaft disposed between a top portion thereof and the bottom portion thereof and a tope portion of the rudder blade; and a second horizontal arm connecting a bottom portion of the shaft to a bottom portion of the rudder blade such that an open rectangular space is formed between the first horizontal arm, the second horizontal arm and the rudder blade.

In still another exemplary embodiment, the at least one arm can include a horizontal arm connecting a bottom portion of the shaft to a top portion of the rudder blade such that the rudder blade is disposed at a distance from the rotatable shaft and the rudder blade forms an outer circumference around an axis of the rotatable shaft as the rotatable shaft is rotated.

In yet another exemplary embodiment, the at least one arm can include an angled arm connecting a bottom portion of the shaft to a middle portion of the rudder blade such that the rudder blade is disposed at a distance from the rotatable shaft and the rudder blade forms an outer circumference around an axis of the rotatable shaft as the rotatable shaft is rotated.

In yet another exemplary embodiment, the rudder can be formed of one of a stainless steel, a carbon fiber, wood, or high strength stainless steel.

In still another exemplary embodiment, the rudder blade can include tapered sides to aerodynamically traverse through fluid or air.

The foregoing and/or other features and utilities of the present general inventive concept may be achieved by providing a rudder used to turn a watercraft or an aerial vehicle, comprising: an elongated rotatable shaft; a rudder blade disposed at a distance away from the elongated shaft; and at least one extension arm connecting the elongated shaft to the rudder blade.

In an exemplary embodiment, the at least one extension arm can comprise a pair of extension arms disposed in parallel.

In another exemplary embodiment, the at least one extension arm can comprise a pair of extension arms disposed at different angles with respect to each other.

The foregoing and/or other features and utilities of the present general inventive concept may be achieved by providing a rudder used to turn a watercraft, aerial vehicle, or other vehicle moving through a fluid medium comprising: an elongated rudder blade; first and second connection arms, the first connection arm being connected at a first end thereof to an upper portion of the rudder blade and the second connection arm being connected at a first end thereof to a lower portion of the rudder blade such that the first and second connection arms extend in parallel away from the rudder blade; and first and second hinges, the first hinge being connected at a first side thereof to a second end of the first connection arm and the second being connected at a first side thereof to a second end of the second connection arm, wherein when the first and second hinges are connected at second sides thereof to a stern of a watercraft the rudder blade is disposed by a predetermined distance away from the stern of the watercraft.

In an exemplary embodiment, the rudder blade can be formed in a rectangular shape from the top portion thereof to the bottom portion thereof.

### BRIEF DESCRIPTION OF THE DRAWINGS

These and/or other features and utilities of the present inventive concept will become apparent and more readily appreciated from the following description of the embodiments, taken in conjunction with the accompanying drawings of which:

FIG. 1 illustrates a conventional rudder for a watercraft;

FIG. 2 illustrates a rudder apparatus for a watercraft, according to an example embodiment of the present inventive concept;

FIG. 3 illustrates a rudder apparatus for a watercraft, according to another example embodiment of the present inventive concept;

FIG. 4 illustrates a rudder apparatus for a watercraft, according to still another example embodiment of the present inventive concept;

FIG. 5 illustrates a rudder apparatus for a watercraft, according to yet another example embodiment of the present inventive concept; and

FIG. 6 illustrates a rudder apparatus for a watercraft, according to yet another example embodiment of the present inventive concept.

FIG. 7 illustrates a rudder apparatus for a watercraft, according to yet another example embodiment of the present inventive concept.

The drawings illustrate a few example embodiments of the present inventive concept, and are not to be considered limiting in scope, as the overall inventive concept may admit to other equally effective embodiments. The elements and features shown in the drawings are not to scale and attempt to clearly illustrate the principles of exemplary embodiments of the present inventive concept. In the drawings, reference numerals designate like or corresponding, but not necessarily identical, elements throughout the several views.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted.

It will be understood that although the terms “first” and “second” are used herein to describe various elements, these elements should not be limited by these terms. These terms are only used to distinguish one element from another element. Thus, a first element could be termed a second element, and similarly, a second element may be termed a first element without departing from the teachings of this disclosure.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

Hereinafter, one or more exemplary embodiments of the present general inventive concept will be described in detail with reference to accompanying drawings.

Example embodiments of the present general inventive concept are directed to a rudder apparatus designed to significantly decrease a drag near the centerline of a watercraft when turning the watercraft and to increase the turning efficiency of the watercraft.

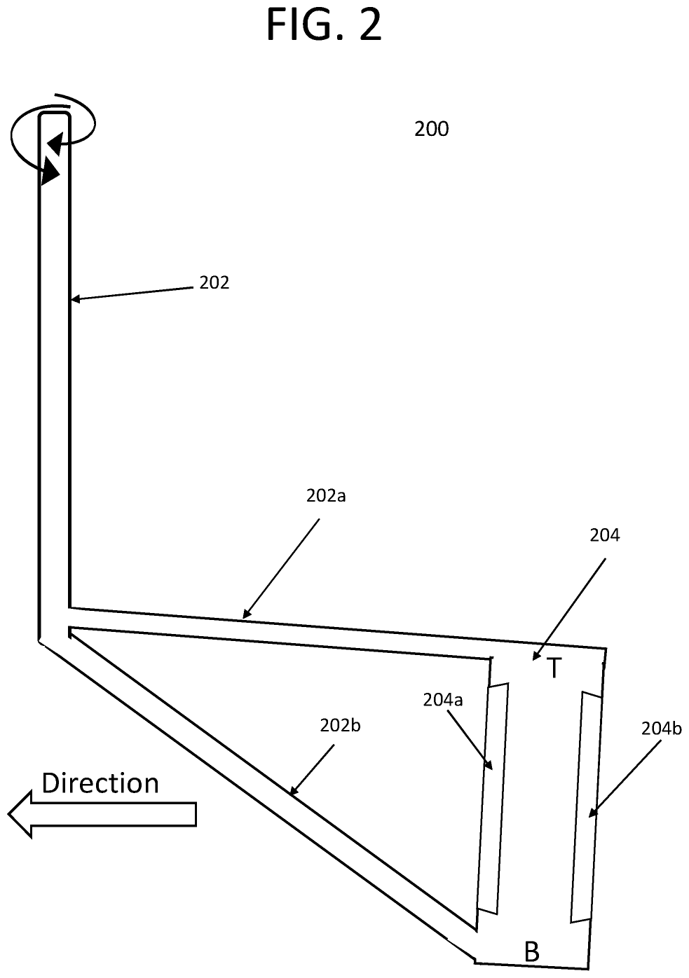

FIG. 2 illustrates a rudder apparatus 200 for a watercraft, such as, for example, a kayak, a canoe, a sailboat, larger watercrafts, or for aerial vehicles, etc. (not illustrated here in order to provide brevity to the detailed description herein), according to an example embodiment of the present inventive concept. Although the rudder apparatus 200 can be used for a plurality of different types of water and aerial vehicles, a watercraft will be referenced herein for brevity of the detailed description. Referring to FIG. 2, the rudder apparatus 200 can include a rotatable shaft 202. The rotatable shaft 202 connects the rudder apparatus 200 to a watercraft. It is to be noted that the rudder apparatus 200 can be connected to and used to control the direction of any type of vessel which is used to traverse through a fluid, such as water, or air, without departing from the spirit and scope of the overall inventive concept, as described herein. The rotatable shaft 202 is preferably disposed at a stern end of a watercraft and along a centerline thereof (i.e., between the port side and the starboard side thereof). The shaft 202 can be formed of a stainless steel, a carbon fiber composite, wood, aluminum, or any other material or composition of materials that will withstand forces caused by traversing through water or air at high speeds.

The rudder apparatus 200 according to this example embodiment can also include a rectangular shaped rudder blade 204, which is generally configured to extend below the watercraft and be completely submerged within the water in order to create a drag with the water to turn the watercraft in which the rudder apparatus 200 is attached. However, the rudder blade 204 can have any shape that will perform the intended purposes as described herein without departing from the spirit and scope of the overall inventive concept.

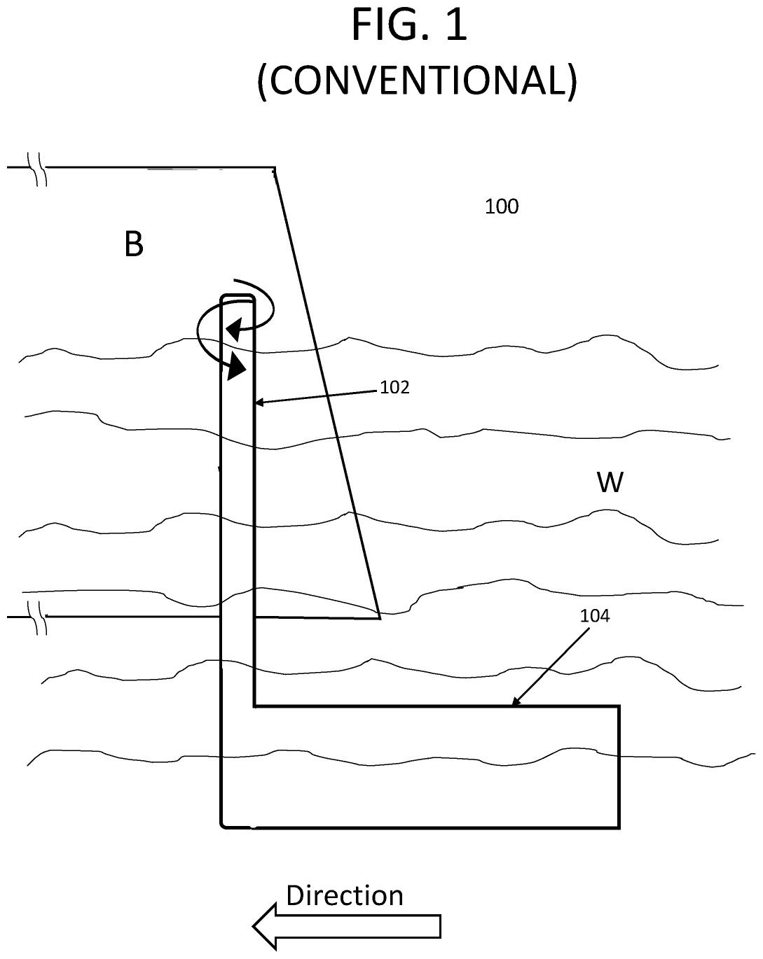

In contrast with conventional rudders, such as the rudder 100 illustrated in FIG. 1, the rudder apparatus 200 according to this example embodiment is designed to have the rudder blade 204 connected to the rotatable shaft 202 while also being disposed a distance away from the rotatable shaft 202. More specifically, a first “horizontal connection arm” 202a can include a first end thereof which is connected to a lower end or bottom of the rotatable shaft 202 and a second end thereof which is connected to a top T portion of the rudder blade 204. The rudder apparatus 200 is also designed to have a second “angled connection arm” 202b that includes a first end thereof which is connected to the lower end or bottom of the rotatable shaft 202 and a second end thereof which is connected to a bottom B portion of the rudder blade 204. According to this example embodiment, the first horizontal connection arm 202a, the second angled connection arm 202b and one side of the rudder blade 204 together form a triangle shape. Within the triangle is an open space in which water (or other fluid) can flow freely through when the rudder apparatus 200 is placed in the water and rotated slightly in either the clockwise or counterclockwise directions such that the rudder blade 204 creates a drag with the water. Alternatively, the rudder 200, including the rudder blade 204, the first horizontal connection arm 202a and the second angled connection arm 202b combination can have a longitudinal shape, a round shape, a square shape, or an airfoil or hydrofoil shape.

It is to be noted that when the rudder 200 is used with, and therefore connected to an aerial vehicle, drag and lift are created with respect to air. It is also to be noted that the rudder apparatus 200 can be formed of stainless steel, wood, aluminum, plastics, a carbon fiber composite, or any other material or composition of materials that will withstand forces caused by traversing through water at high speeds. The material in which the rudder can be made from can vary depending on the type of watercraft or aerial vehicle in which the rudder is intended to be connected to and used therewith, without departing from the spirit and scope of the overall present inventive concept. For example, while wood or stainless steel may be used with a kayak or canoe, a high strength stainless steel may be used with a large watercraft (i.e., vessel) or aerial vehicle. The rotatable shaft 202, rudder blade 204, first horizontal connection arm 202a and second angled connection arm 202 of the rudder apparatus 200 can be formed together as one single body (i.e., a molding process or a heating and shaping process) or can be formed of separate parts that are welded/attached together to form the rudder apparatus as illustrated in FIG. 2.

With the configuration of the rudder apparatus 200, as described above and illustrated in FIG. 2, since the entire surface area of the rudder blade 204 is disposed a distance away from the centerline of the watercraft (i.e., away from the rotatable shaft 202) when the shaft 202 is rotated in either clockwise or counterclockwise directions, no drag is created close to the centerline of the watercraft or close to the rotatable shaft 202. This result is significant since drag created near the centerline of a watercraft is not efficient for turning the watercraft yet can significantly slow the watercraft down in the water. Furthermore, since the entire surface area of the rudder blade 204 is disposed away from the centerline of the watercraft when the shaft 202 is rotated in either clockwise or counterclockwise directions a greater turning pitch (or yaw) of the watercraft is created because the further away a drag is created from the centerline of the watercraft the greater efficiency of the drag created to turn the watercraft.

According to an example embodiment both sides of the rudder blade 204 can be tapered inward (see 204a and 204b) to create sharp edges in order to increase the aerodynamic flow of the rudder blade 204 through the water.

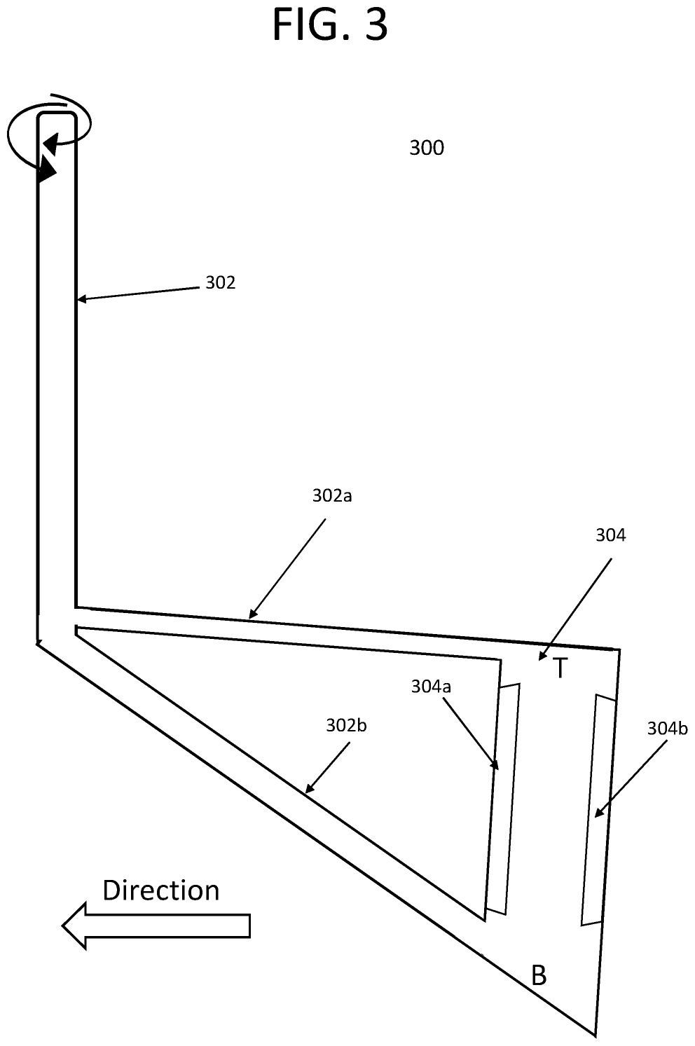

FIG. 3 illustrates a rudder apparatus 300 for a watercraft, such as, for example, a kayak, a canoe, sailboat, etc. (not illustrated here in order to provide brevity to the detailed description herein), according to another example embodiment of the present inventive concept. Referring to FIG. 3, a solid rotatable shaft 302 can be separate from while being connected to a rudder blade 304. More specifically, a first “horizontal connection arm” 302a can have a first end thereof which is connected to a lower or bottom end of the rotatable shaft 302 and a second end thereof which is connected to a top T portion of the rudder blade 304, and a second “angled connection arm” 302b can include a first end thereof which is connected to the lower or bottom end of the rotatable shaft 302 and a second end thereof which is connected to a bottom B portion of the rudder blade 304, similar to the rudder apparatus 200 illustrated in FIG. 2. However, in the example embodiment of FIG. 3 the rudder blade 304 can be formed to have an angular bottom B. More specifically, the bottom B of the rudder blade 304 can be aligned with and integral with an outer surface of the second angled connection arm 302b while the first horizontal arm 302a forms a perpendicular angle with the top T of the rudder blade 304.

With the configuration of the rudder apparatus 300, as described above and illustrated in FIG. 3, since the entire surface area of the rudder blade 304 is displaced away from the centerline of the watercraft (i.e., away from the rotatable shaft 302) when the shaft 302 is rotated in either clockwise or counterclockwise directions, no drag is created near the centerline of the watercraft or near the rotatable shaft 302. This result is significant since drag created near the centerline of a watercraft is not efficient for turning the watercraft yet can significantly slow the watercraft down in the water. Furthermore, since the entire surface area of the rudder blade 304 is disposed away from the centerline of the watercraft when the shaft 302 is rotated in either clockwise or counterclockwise directions, a greater turning pitch (or yaw) of the watercraft is created because the further away a drag is created from the centerline of the watercraft the greater efficiency of the drag created to turn the watercraft.

According to an example embodiment both sides of the rudder blade 304 can be tapered inward (see 304a and 304b) to create sharp edges in order to increase the aerodynamic flow of the rudder blade 304 through the water.

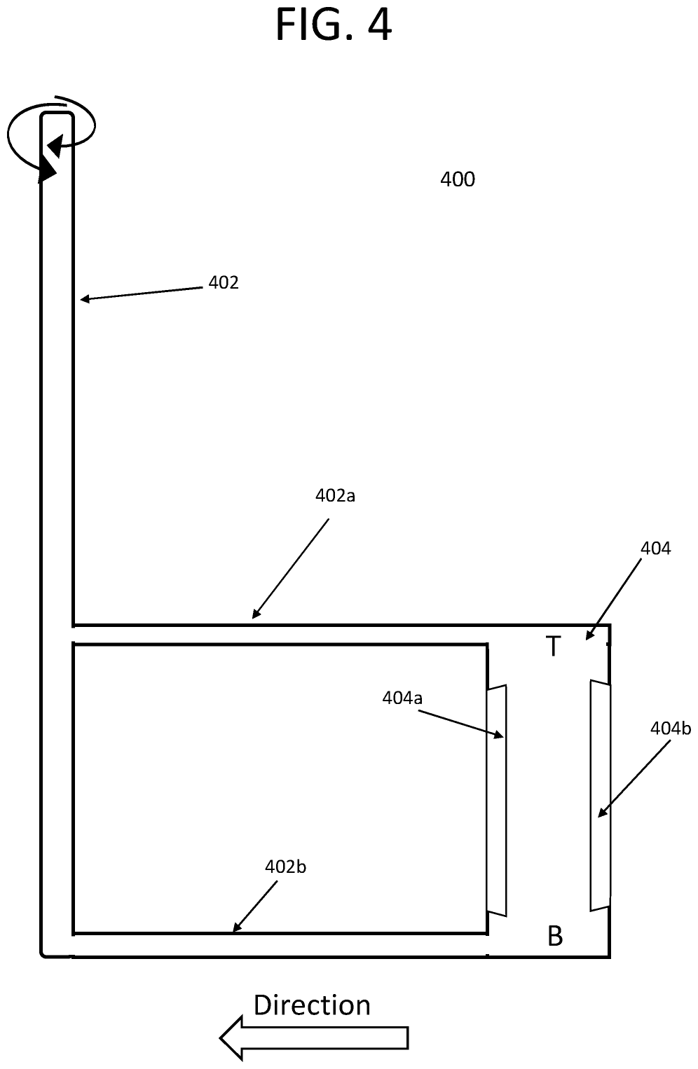

FIG. 4 illustrates a rudder apparatus 400 for a watercraft, such as, for example, a kayak, a canoe, sailboat, etc. (not illustrated in order to provide brevity to the detailed description herein), according to still another example embodiment of the present inventive concept. In this example embodiment, a solid rotatable shaft 402 is distally connected to a rudder blade 404. More specifically, a first horizontal connection arm 402a and a second horizontal connection arm 402b can be connected to and disposed between the rotatable shaft 402 and the rudder blade 404. The first horizontal connection arm 402a and the second horizontal connection arm 402b are configured to be in parallel with each other and spaced apart from each other. A first end of the first horizontal connection arm 402a can be connected to a mid to lower section of the solid rotatable shaft 402 and a second end of the first horizontal connection arm 402a can be connected to a top T portion of the rudder blade 404, and a first end of the second horizontal connection arm 402b can be connected to a bottom end of the solid rotatable shaft 402 while a second end of the second horizontal connection arm 402b can be connected to a bottom B portion of the rudder shaft 404. With this configuration a square shape is formed between the rotatable shaft 402, the first and second horizontal connections arms 402a, 402b and the rudder blade 404, with a square open inner section therebetween.

With the configuration of the rudder apparatus 400 as described above and illustrated in FIG. 4, since the entire surface area of the rudder blade 404 is displaced away from the centerline of the watercraft (i.e., away from the rotatable shaft 402) when the rotatable shaft 402 is rotated in either clockwise or counterclockwise directions, no drag is created near the centerline of the watercraft or near the rotatable shaft 402. This result is significant since drag created near the centerline of a watercraft is not efficient for turning the watercraft yet can significantly slow the watercraft down in the water. Furthermore, since the entire surface area of the rudder blade 404 is disposed away from the centerline of the watercraft when the rotatable shaft 402 is rotated in either clockwise or counterclockwise directions, a greater turning pitch (or yaw) of the watercraft is created because the further away a drag is created from the centerline of the watercraft the greater efficiency of the drag created to turn the watercraft.

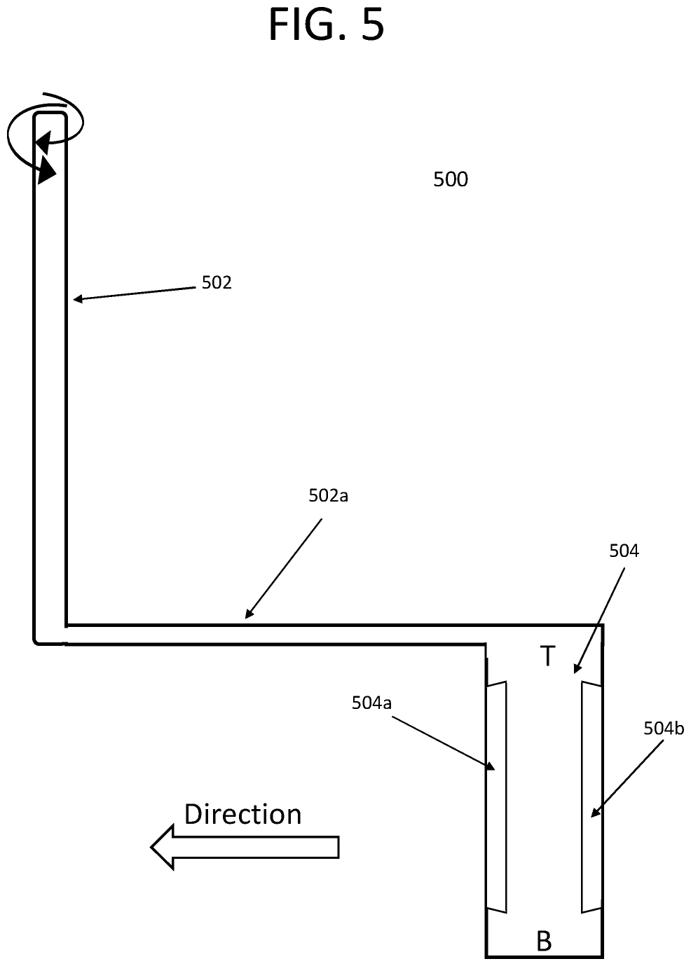

FIG. 5 illustrates a rudder apparatus 500 for a watercraft, such as, for example, a kayak, a canoe, sailboat, etc. (not illustrated in order to provide brevity to the detailed description herein), according to still another example embodiment of the present inventive concept. In this example embodiment, a solid rotatable shaft 502 is distally connected to a rudder blade 504. More specifically, a single connection arm 502a can be disposed between the rotatable shaft 402 and the rudder blade 404. The single connection arm 502a can include a first end thereof which can be connected to a lower or bottom end of the solid rotatable shaft 502 and a second end thereof which can be connected to a top T portion of the rudder blade 404. A bottom B portion of the rudder blade 504 is completely submerged in the water when in use, and preferably the top T of the rudder blade 504 is also completely submerged in water when in use. It is to be noted that the single connection arm 502a can be designed to be disposed in a horizontal position between the rotatable shaft 502 and the rudder blade 504 to form perpendicular angles with the rotatable shaft 502 and the rudder blade 504, or can alternatively be disposed at a slight downward angle from the rotatable shaft 502 to the rudder blade 504.

With the configuration of the rudder apparatus 500, as described above and illustrated in FIG. 5, since the entire surface area of the rudder blade 504 is displaced away from the centerline of the watercraft (i.e., away from the rotatable shaft 502) when the shaft 502 is rotated in either clockwise or counterclockwise directions, no drag is created near the centerline of the watercraft or near the rotatable shaft 502. This result is significant since drag created near the centerline of a watercraft is not efficient for turning the watercraft yet can significantly slow the watercraft down in the water. Furthermore, since the entire surface area of the rudder blade 504 is disposed away from the centerline of the watercraft when the shaft 502 is rotated in either clockwise or counterclockwise directions, a greater turning pitch (or yaw) of the watercraft is created because the further away a drag is created from the centerline of the watercraft the greater efficiency of the drag created to turn the watercraft.

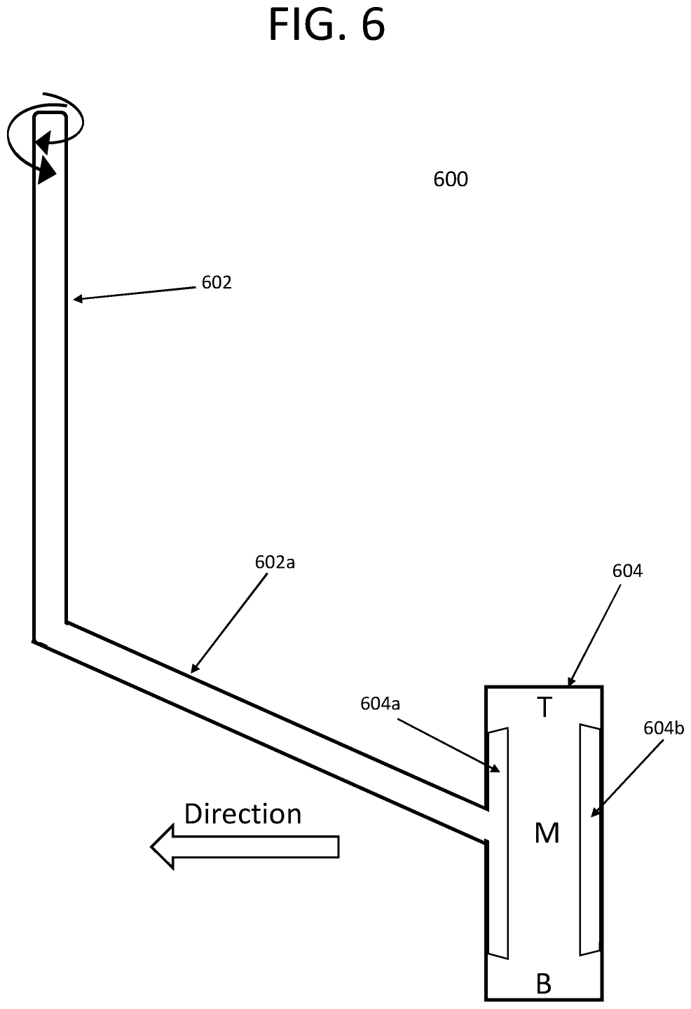

FIG. 6 illustrates a rudder apparatus 600 for a watercraft, such as, for example, a kayak, a canoe, sailboat, etc. (not illustrated in order to provide brevity to the detailed description herein), according to still another example embodiment of the present inventive concept. In this example embodiment, a solid rotatable shaft 602 is distally connected to a rudder blade 604. More specifically, a single connection arm 602a can be disposed between the rotatable shaft 602 and the rudder blade 604. In this example embodiment, the single connection arm 602a can include a first end thereof which can be connected to a lower or bottom end of the solid rotatable shaft 602 and extend at an angle downward from the rotatable shaft 602, and a second end thereof which can be connected to a middle M portion of the rudder blade 604. More specifically, the single connection arm 602a is configured to be at an angle with respect to both the solid rotatable shaft 602 and the rudder blade 604A. It is to be noted that the single connection arm 602a can be designed to be disposed to be connected to other portions of the rudder blade 604 alternatively to the middle M portion without departing from the spirit and scope of the overall inventive concept.

With the configuration of the rudder apparatus 600, as described above and illustrated in FIG. 6, since the entire surface area of the rudder blade 604 is displaced away from the centerline of the watercraft (i.e., away from the rotatable shaft 602) when the shaft 602 is rotated in either clockwise or counterclockwise directions, no drag is created near the centerline of the watercraft or near the rotatable shaft 602. This result is significant since drag created near the centerline of a watercraft is not efficient for turning the watercraft yet can significantly slow the watercraft down in the water. Furthermore, since the entire surface area of the rudder blade 604 is disposed away from the centerline of the watercraft when the shaft 602 is rotated in either clockwise or counterclockwise directions, a greater turning pitch (or yaw) of the watercraft is created because the further away a drag is created from the centerline of the watercraft the greater efficiency of the drag created to turn the watercraft.

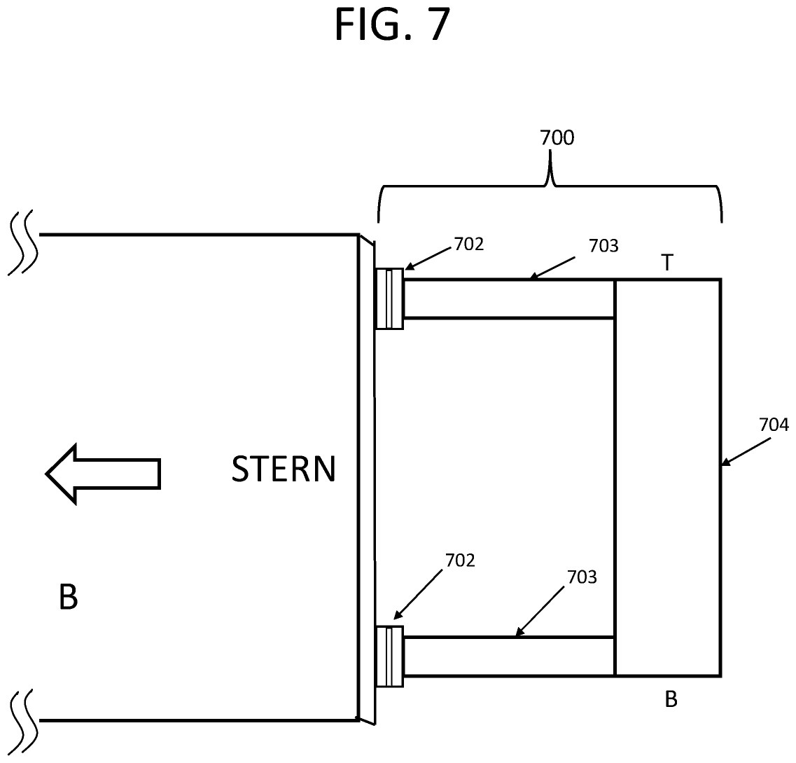

FIG. 7 illustrates a rudder apparatus 700 for a watercraft B, such as, for example, a kayak, a canoe, sailboat, etc. (not illustrated in order to provide brevity to the detailed description herein), according to still another example embodiment of the present inventive concept. In this example embodiment, a pair of hinges 702 can be connected to the stern end of a watercraft B. The hinges 702 can also be connected to a first end of a corresponding connection arm 703 such that the connection arms 703 can pivot clockwise and counterclockwise with respect to the watercraft B. Each of the connection arms can also be connected at a second end thereof to a rudder blade 704. For example, a first connection arm 703 can be connected to a top portion T of the rudder blade 704 and a second connection arm 703 can be connected to a bottom portion B of the rudder blade 704. As the connection arms 703 are pivoted the rudder blade 704 is also pivoted to create a draft in the water. There exist several different methods to control movement of the rudder 700 according to this example embodiment. One common method is the use of a tiller, which is used with most small sailboats. Another known method of controlling the movement of such a rudder 700 is an actuator cable (or rod), which is commonly used with light aircraft. Since these methods of controlling movement of a rudder are commonly used, they are not illustrated or described in detail in order to maintain brevity of the detailed description.

With the configuration of the rudder apparatus 700, as described above and illustrated in FIG. 7, since the entire surface area of the rudder blade 704 is displaced away from the centerline of the watercraft B when the connection arms 703 are rotated about their respective hinges 702 in either clockwise or counterclockwise directions, no drag is created near the centerline of the watercraft B. This result is significant since drag created near the centerline of a watercraft B is not efficient for turning the watercraft yet can significantly slow the watercraft B down in the water. Furthermore, since the entire surface area of the rudder blade 704 is disposed away from the centerline of the watercraft B when the connection arms 703 are rotated in either clockwise or counterclockwise directions about their respective hinges 702, a greater turning pitch (or yaw) of the watercraft B is created because the further away a drag is created from the centerline of the watercraft B the greater efficiency of the drag created to turn the watercraft B. It is to be noted that the rudder blade 704 can have a rectangular shape, or any other shape that will create perform the intended purposes as described herein without departing from the spirit and scope of the overall present inventive concept.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A rudder used to turn a watercraft, aerial vehicle, or other vehicle moving through a fluid medium, comprising:
an elongated rotatable shaft;
a rudder blade extending in parallel with the elongated shaft; and
at least one arm connecting the elongated shaft to the rudder blade such that the rudder blade is disposed at a distance away from the elongated shaft.

2. The rudder according to claim 1, wherein at least one arm includes:
a first horizontal arm connecting a bottom portion of the shaft to a top portion of the rudder blade; and
a second angled arm connecting a bottom portion of the shaft to a bottom portion of the rudder blade such that an open triangular space is formed between the first horizontal arm, the second angled arm and the rudder blade.

3. The rudder according to claim 2, wherein the bottom portion of the rudder blade is parallel with the top portion of the rudder blade.

4. The rudder according to claim 2, wherein the bottom portion of the rudder blade is formed to have a same angle as the second angled arm and is integral therewith.

5. The rudder according to claim 1, wherein the at least one arm includes:
a first horizontal arm connecting a portion of the shaft disposed between a top portion thereof and the bottom portion thereof and a tope portion of the rudder blade; and
a second horizontal arm connecting a bottom portion of the shaft to a bottom portion of the rudder blade such that an open rectangular space is formed between the first horizontal arm, the second horizontal arm and the rudder blade.

6. The rudder according to claim 1, wherein the at least one arm includes:
a horizontal arm connecting a bottom portion of the shaft to a top portion of the rudder blade such that the rudder blade is disposed at a distance from the rotatable shaft and the rudder blade forms an outer circumference around an axis of the rotatable shaft as the rotatable shaft is rotated.

7. The rudder according to claim 1, wherein the at least one arm includes:
an angled arm connecting a bottom portion of the shaft to a middle portion of the rudder blade such that the rudder blade is disposed at a distance from the rotatable shaft and the rudder blade forms an outer circumference around an axis of the rotatable shaft as the rotatable shaft is rotated.

8. The rudder according to claim 1, wherein the rudder is formed of one of a stainless steel, a carbon fiber, wood, plastics, composites or high strength stainless steel.

9. The rudder according to claim 1, wherein the rudder blade includes tapered sides to aerodynamically traverse through fluid or air.

10. The rudder according to claim 1, wherein the rudder blade is formed at least one of an aerodynamic or hydrodynamic foil shape to minimize drag.

11. A rudder used to turn a watercraft or an aerial vehicle, comprising:
an elongated rotatable shaft;
a rudder blade disposed at a distance away from the elongated shaft; and
at least one extension arm connecting the elongated shaft to the rudder blade.

12. The rudder according to claim 11, wherein the at least one extension arm comprises a pair of extension arms disposed in parallel.

13. The rudder according to claim 11, wherein the at least one extension arm comprises a pair of extension arms disposed at different angles with respect to each other.

14. A rudder used to turn a watercraft, aerial vehicle, or other vehicle moving through a fluid medium, comprising:
an elongated rudder blade;
first and second connection arms, the first connection arm being connected at a first end thereof to an upper portion of the rudder blade and the second connection arm being connected at a first end thereof to a lower portion of the rudder blade such that the first and second connection arms extend in parallel away from the rudder blade; and
first and second hinges, the first hinge being connected at a first side thereof to a second end of the first connection arm and the second being connected at a first side thereof to a second end of the second connection arm,
wherein when the first and second hinges are connected at second sides thereof to a stern of a watercraft the rudder blade is disposed by a predetermined distance away from the stern of the watercraft.

15. The rudder according to claim 14, wherein the rudder blade is formed in a rectangular shape from the top portion thereof to the bottom portion thereof.
